(19) United States
(12) Patent Application Publication
(10) Pub. No.: US 2026/0243222 A1
(43) Pub. Date: Aug. 20, 2026

(54) SYSTEM AND METHOD FOR DETECTING ENGINE CONDITIONS USING IGNITION SYSTEM

(71) Applicant: Altronic LLC, Girard, OH (US)

(72) Inventors: David Lepley, Chagrin Falls, OH (US); Matthew Traina, Ravenna, OH (US)

(21) Appl. No.: 19/544,020

(22) Filed: Feb. 19, 2026

Related U.S. Application Data
(60) Provisional application No. 63/760,252, filed on Feb. 19, 2025.

(51) Int. Cl. F02P 17/12; F02P 11/06

(52) U.S. Cl. CPC F02P 17/12; F02P 11/06; F02P 2017/121; F02P 2017/123

(57) ABSTRACT

A system and method for determining engine conditions using an ignition system. An ignition coil assembly has an ignition transformer with primary windings and secondary windings. A control unit is adapted to send excitation pulses to the primary windings to generate a spark at a spark apparatus and ignite a fuel-air mixture in a cylinder of an engine. The control unit is adapted to send additional excitation pulses to the primary windings at times other than to generate a spark at the spark apparatus and ignite a fuel-air mixture in a cylinder of an engine. The control unit is adapted to determine engine conditions using measurements of the ignition coil after the additional excitation pulses.

### FIELD

The present teachings relate generally to power electronics and, more particularly, to ignition systems that may be used with combustion engines.

### BACKGROUND

In general, an ignition system generates a high voltage that is sent to a spark plug to create a spark, as is appreciated by one skilled in the art. The spark in turn ignites a fuel-air mixture in an engine's combustion chamber(s) to drive the engine. The ignition coil (also referred to as ignition transformer) typically produces the high voltage. US Pat. No. 7,401,603, assigned to Altronic LLC, entitled “High tension capacitive discharge ignition with reinforcing triggering pulses”, discloses an ignition system and is incorporated by reference in its entirety.

US Pat. No. 12,546,279, assigned to Altronic LLC, entitled “Adaptive Spark Energy Control”, discloses a system for modifying characteristics of a spark and is incorporated by reference in its entirety.

U.S. Pat. No. 5,383,350, entitled “Sensor and method for detecting misfires in internal combustion engines”, discloses sensing an occurrence of an arc across the spark gap.

U.S. Pat. No. 9,429,132, entitled “Capacitive ignition system with ion-sensing and suppression of AC ringing”, discloses ion sensing at the spark gap.

While prior systems have sought to measure electrical characteristics of an ignition coil during a normal firing event (for generating a spark), they lack abilities to measure what is happening in the ignition coil at other times. Therefore, it would be beneficial to have an alternative system and method for detecting engine conditions using ignition system.

### SUMMARY

The needs set forth herein as well as further and other needs and advantages are addressed by the present embodiments, which illustrate solutions and advantages described below.

One embodiment of a system according to the present teachings includes, but is not limited to, an ignition system. An ignition coil assembly has an ignition transformer with primary windings and secondary windings. A control unit is adapted to send excitation pulses to the primary windings to generate a spark at a spark apparatus and ignite a fuel-air mixture in a cylinder of an engine. The control unit is adapted to send additional excitation pulses to the primary windings at times other than to generate a spark at the spark apparatus and ignite a fuel-air mixture in a cylinder of an engine. The control unit determines engine conditions using measurements of the ignition coil after the additional excitation pulses.

In one embodiment, the additional excitation pulses are sent during an exhaust stroke and the determined engine conditions include a quality of engine combustion.

In one embodiment, the measurements comprise secondary voltage and/or current.

In one embodiment, the additional excitation pulses are sent when a cylinder is unstable, the measurements include secondary voltage, and the determined engine conditions include characteristics of combustion.

In one embodiment, algorithms are applied to the measurements to identify the characteristics of combustion.

In one embodiment, a datastore has stored measurements associated with stored engine conditions, such that the control unit determines the engine conditions by comparing the measurements with the stored measurements.

One embodiment of a system according to the present teachings includes, but is not limited to, an engine system. It includes an engine and the ignition system according to the present teachings.

In one embodiment, a datastore has an algorithm for measuring conditions in the cylinder, such that the algorithm is applied to the measurements to determine whether combustion occurred.

In one embodiment, the algorithm is applied to the measurements to determine the type of combustion that occurred.

In one embodiment, the determined engine conditions comprise a dangerous or unstable combustion situation, and the control unit is adapted to alert a user of the situation.

One embodiment of a system according to the present teachings includes, but is not limited to, an ignition system. An ignition coil assembly has an ignition transformer with primary windings and secondary windings. A control unit is adapted to send one or more excitation pulses to the primary windings to generate a spark at a spark apparatus and ignite a fuel-air mixture in a cylinder of an engine. The control unit is adapted to send one or more additional excitation pulses to the primary windings at times other than to generate a spark at the spark apparatus and ignite a fuel-air mixture in a cylinder of an engine. A datastore has stored measurements associated with stored engine conditions. The control unit is adapted to determine engine conditions by comparing measurements of the ignition coil after the one or more additional excitation pulses with the stored measurements.

In one embodiment, the one or more additional excitation pulses are sent during an exhaust stroke.

In one embodiment, the stored measurements comprise secondary energy over time, and the determined engine conditions comprises one or more combustion characteristics.

One embodiment of a system according to the present teachings includes, but is not limited to, an engine system. It includes an engine having a plurality of cylinders and the ignition system according to the present teachings.

One embodiment of a method according to the present teachings includes, but is not limited to, a method for controlling an ignition system. It includes providing an ignition coil assembly having an ignition transformer with primary windings and secondary windings, sending one or more excitation pulses to the primary windings to generate a spark at a spark apparatus and ignite a fuel-air mixture in a cylinder of an engine, sending one or more additional excitation pulses to the primary windings at times other than to generate a spark at the spark apparatus and ignite a fuel-air mixture in a cylinder of an engine, and determining one or more engine conditions using measurements of the ignition coil after the one or more additional excitation pulses.

In one embodiment, a control unit is provided that is adapted to perform the sending and the determining.

In one embodiment, a datastore is provided having stored measurements associated with stored engine conditions. The determining includes comparing the measurements with the stored measurements.

In one embodiment, the stored measurements comprise secondary energy over time and the determined engine conditions comprise a combustion characteristic.

In one embodiment, the determining includes identifying a dangerous or unstable combustion situation. Future excitation pulses are adjusted to mitigate the situation.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an illustration of one embodiment of an ignition system according to the present teachings.

FIG. 2 is an illustration of one embodiment of an engine control system according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of a patent issued on this application in interpreting the claims appended hereto, it is noted that none of the appended claims or claim elements are intended to invoke 35 U.S.C. 112(f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

In the past, ignition spark diagnostics have been used to gain insight into engine operation but have been based on measurements taken during a normal firing event of the ignition transformer (i.e., at/around the time of a spark), such as during the power/combustion stroke.

An engine stroke refers to the travel of a piston along a cylinder in either direction, as is appreciated by one skilled in the art. In a four-stroke engine, for example, there are four separate strokes: intake (piston travelling down), compression (piston travelling up), power/combustion (piston travelling down), and exhaust (piston travelling up). Intake is when the air-fuel mixture is drawn in, compression is when the air-fuel mixture is compressed, power is when explosion forces the piston down (i.e., due to spark event), and exhaust is when burned gases are pushed out. As the piston moves it turns the crankshaft.

In accordance with the present teachings, measurements are used to gain insight into engine conditions at times other than when a spark event is desired, such as during the exhaust stroke, an unfueled engine cycle, etc., although not limited thereto.

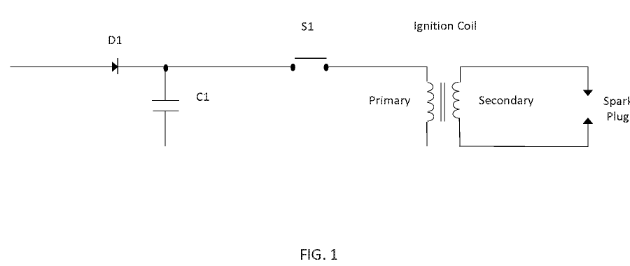

Referring now to FIG. 1, shown is an illustration of one embodiment of an ignition system according to the present teachings. Shown is a simplified electrical schematic where power is supplied through diode D1 to charge capacitor C1 (although D1 and C1 may not be required according to the present teachings). A control unit (not shown) controls switch S1 to send pulses of energy to the primary of the ignition coil, which flows to the secondary. In this way, the ignition coil may generate a high voltage that is sent to a spark apparatus (e.g., spark plug) to create a spark.

As explained in US Pat. No. 7,401,603, secondary voltage can be measured to time reinforcing pulses and produce a spark having a desired energy envelope. Pulses added on a downswing of the secondary voltage waveform may reinforce whereas pulses added on an upswing may dampen.

Prior systems have measured engine conditions during normal ignition spark timing, such as the power/combustion stroke. According to the present teachings, an ignition system measures engine conditions at times other than the normal ignition spark timing. It may send primary pulses to the ignition transformer and measure electrical characteristics responsive to those pulses, although not limited thereto.

The present teachings provide new engine diagnostic tools not previously contemplated. In one example, an excitation pulse can be sent to the ignition transformer during the exhaust stroke cycle to determine the presence and quality of engine combustion. In another example, excitation pulses can be sent when cylinder conditions may be unstable, such that the resulting secondary voltage may have algorithms applied to determine the characteristics of the combustion, although not limited thereto. In this way, the present teaching can be used to determine whether combustion occurred and the type of combustion.

The present teachings provide a number of benefits. For example, the teachings may be used to send a pulse of a known voltage capability to measure if in-cylinder conditions are above or below the known breakdown voltage sent. In another example, they could be used to send a pulse of a known width to achieve a breakdown to measure the voltage and/or current and determine cylinder conditions. The present teachings afford the ability to apply various algorithms to measure conditions in the cylinder, as is appreciated by one skilled in the art. For example, an algorithm may be used to observe detonation.

Measurements used in accordance with the present teachings may include secondary voltage (at the spark gap or within the ignition coil), secondary current, ion-sense current, spark duration, as well as combinations thereto, although not limited thereto. One skilled in the art appreciates that a variety of measurement (e.g., electrical) may be taken in order to measure the response to the excitation pulses.

Useful times for taking measurements include after a spark to detect combustion, during the potential for detonation (end-gas autoignition), during the exhaust stroke cycle, during an un-fueled cycle, etc. Measurements can be done at any time (e.g., other than known prior art uses to achieve a spark event) in order to determine conditions of an engine. Measurements may be taken after sending one or more excitation pulses, although not limited thereto. In other words, measurements can be taken as any time according to a specific use-case, as is appreciated by one skilled in the art.

A system according to the present teachings may include a datastore (e.g., database, etc.) of engine conditions as well as associated measurements and/or ranges of measurements. These may come from modeling, testing, experimentation, etc., although not limited thereto. The datastore may provide reference information so that taken measurements can be mapped to measurements in the datastore to identify engine conditions, although not limited thereto.

As an example, the datastore may include predetermined secondary energy plotted against time, which may be based on modeling and/or validation. In this way, real-time secondary energy can be compared to information in the datastore and decisions can be made about combustion characteristics. One skilled in the art appreciates the various engine conditions, associated measurements, and ranges of measurements that may be provided in the datastore.

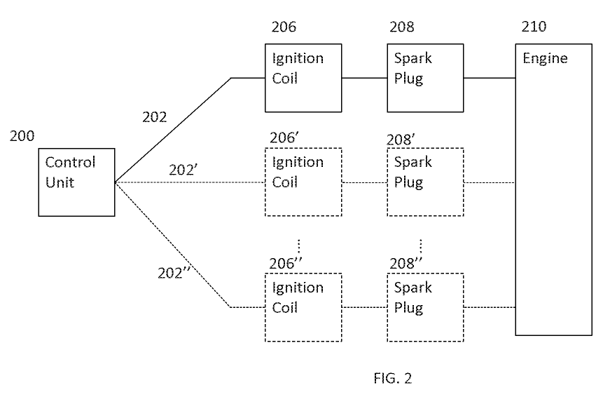

Referring now to FIG. 2, shown is an illustration of one embodiment of an engine control system according to the present teachings. As shown, a control unit 200 may be in electronic communication with one or more ignition coils 206, 206’, 206’’. Communication between the control unit 200 and ignition coils 206, 206’, 206’’ may be performed over one or more communication links 202, 202’, 202’’. Each coil may send energy to a spark plug 208, 208’, 208’’. The spark plugs may in turn drive crankshafts in an engine 210 (e.g., one or more spark plugs in each engine cylinder), as is appreciated by one skilled it the art.

The detection of engine conditions according to the present teachings may come without the need to install additional sensors. In fact, in some instances sensors are not even possible to install, for example, due to harsh in cylinder conditions. And while others can be installed in a lab environment, they may be impractical on a production engine due to cost and mounting limitations, although not limited thereto. Such sensors may require machining, spacing, and cooling. The present teachings avoid the complications associated with additional sensors and help determine things such as whether an engine misfired, why it misfired, and if there are dangerous or unstable combustion situations to be avoided or reported, although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. An ignition system, comprising:
an ignition coil assembly having an ignition transformer with primary windings and secondary windings;
a control unit adapted to send one or more excitation pulses to the primary windings to generate a spark at a spark apparatus and ignite a fuel-air mixture in a cylinder of an engine;
the control unit adapted to send one or more additional excitation pulses to the primary windings at times other than to generate a spark at the spark apparatus and ignite a fuel-air mixture in a cylinder of an engine;
the control unit adapted to determine engine conditions using measurements of the ignition coil after the one or more additional excitation pulses.

2. The system of claim 1, wherein the one or more additional excitation pulses are sent during an exhaust stroke and the determined engine conditions include a quality of engine combustion.

3. The system of claim 1, wherein the measurements comprise secondary voltage and/or current.

4. The system of claim 1, wherein the one or more additional excitation pulses are sent when a cylinder is unstable, the measurements include secondary voltage, and the determined engine conditions include characteristics of combustion.

5. The system of claim 4, wherein algorithms are applied to the measurements to identify the characteristics of combustion.

6. The system of claim 1, further comprising a datastore having stored measurements associated with stored engine conditions, such that the control unit determines the engine conditions by comparing the measurements with the stored measurements.

7. An engine system, comprising:
an engine;
the ignition system of claim 1.

8. The system of claim 1, further comprising a datastore having an algorithm for measuring conditions in the cylinder, such that the algorithm is applied to the measurements to determine whether combustion occurred.

9. The system of claim 8, wherein the algorithm is applied to the measurements to determine the type of combustion that occurred.

10. The system of claim 1, wherein the determined engine conditions comprise a dangerous or unstable combustion situation, and the control unit is adapted to alert a user of the situation.

11. An ignition system, comprising:
an ignition coil assembly having an ignition transformer with primary windings and secondary windings;
a control unit adapted to send one or more excitation pulses to the primary windings to generate a spark at a spark apparatus and ignite a fuel-air mixture in a cylinder of an engine;
the control unit adapted to send one or more additional excitation pulses to the primary windings at times other than to generate a spark at the spark apparatus and ignite a fuel-air mixture in a cylinder of an engine;
a datastore having stored measurements associated with stored engine conditions;
the control unit adapted to determine engine conditions by comparing measurements of the ignition coil after the one or more additional excitation pulses with the stored measurements.

12. The system of claim 11, wherein the one or more additional excitation pulses are sent during an exhaust stroke.

13. The system of claim 11, wherein:
the stored measurements comprise secondary energy over time;
the determined engine conditions comprise a combustion characteristic.

14. An engine system, comprising:
an engine having a plurality of cylinders;
the ignition system of claim 11.

15. A method for controlling an ignition system, comprising:
providing an ignition coil assembly having an ignition transformer with primary windings and secondary windings;
sending one or more excitation pulses to the primary windings to generate a spark at a spark apparatus and ignite a fuel-air mixture in a cylinder of an engine;
sending one or more additional excitation pulses to the primary windings at times other than to generate a spark at the spark apparatus and ignite a fuel-air mixture in a cylinder of an engine;
determining engine conditions using measurements of the ignition coil after the one or more additional excitation pulses.

16. The method of claim 15, further comprising providing a control unit adapted to perform the sending and the determining.

17. The method of claim 15, further comprising providing a datastore having stored measurements associated with stored engine conditions;
wherein the determining includes comparing the measurements with the stored measurements.

18. The method of claim 17, wherein:
the stored measurements comprise secondary energy over time;
the determined engine conditions comprise a combustion characteristic.

19. The method of claim 15, wherein the determining includes identifying a dangerous or unstable combustion situation;
further comprising adjusting future excitation pulses to mitigate the situation.
